(19) United States
(12) Patent Application Publication
(10) Pub. No.: US 2007/0129253 A1
(43) Pub. Date: Jun. 7, 2007

(54) Fatty acid ester blends as carriers for pesticide active ingredients

(76) Inventors: Alefesh Hailu, Cincinnati, OH (US); Timothy H. Anderson, Hamilton, OH (US)

Correspondence Address: COGNIS CORPORATION;PATENT DEPARTMENT, 300 BROOKSIDE AVENUE, AMBLER, PA, 19002, US

(21) Appl. No.: 11/594,674

(22) Filed: Nov. 8, 2006

Related U.S. Application Data
(60) Provisional application No. 60/741,942, filed on Dec. 2, 2005.

(51) Int. Cl. A01N 25/00

(52) U.S. Cl. 504/358; 424/405

(57) ABSTRACT

An agricultural pesticide composition containing: (a) a solvent which is a mixture of fatty acid alkyl esters corresponding to formula I:
R¹CO—OR² (I)
wherein R¹CO is an aliphatic acyl group containing 12 to 18 carbon atoms and R² is a linear or branched alkyl group containing 1 to 4 carbon atoms; and (b) a biologically active ingredient is described. A process of treating a target substrate with the composition is also disclosed.

### CROSS-REFERENCE TO RELATED APPLICATIONS

This application claims priority under 35 U.S.C. § 119(e) from provisional U.S. Patent Application No. 60/741,942, filed on Dec. 2, 2005.

### STATEMENT REGARDING FEDERALLY SPONSORED RESEARCH OR DEVELOPMENT

Not applicable.

### BACKGROUND OF THE INVENTION

It is known that various types of pesticides such as insecticides, insect repellents, fungicides, bactericides, herbicides, and plant growth regulators may be formulated into various products for use on crops and ornamental plants for controlling weeds, insects and the like.

These types of pesticide products may be formulated as liquids, powders or granules. Solvents, emulsifiers, dispersing agents and wetting agents are normally incorporated into such compositions in order to ensure that a uniform pesticide formulation has been prepared.

The successful employment of any pesticide depends upon its proper formulation into a preparation that can be easily diluted with water into ready-to-use mixtures for application onto a targeted pest and/or agricultural substrate with safety to the applicator, animals and plants. The preparation and use of such formulations typically necessitates making them in concentrated form. Thus, the use of auxiliary agents such as solvents, emulsifiers, wetting and dispersing agents are typically required.

Conventionally-used solvents/carriers for pesticides include, among other things, isophorone, methyl isobutyl ketone and N-methylpyrrolidone. These solvents are often times either expensive, difficult to source, and/or undesirable, due to their inherent toxicity or regulatory status. Consequently, there exists a continued need in the pesticide industry to find alternatives to the currently used solvent/carrier systems.

### BRIEF SUMMARY OF THE INVENTION

It has now been surprisingly and unexpectedly discovered by way of the present invention that certain solvent blends of mixtures of fatty acid alkyl esters advantageously possess synergistic solvency and provide improved solubility and uniformity to a pesticide composition.

The present invention is thus directed to a pesticide composition containing:

(a) from about 10 to about 99% by weight of a solvent which is a mixture of fatty acid alkyl esters corresponding to formula I:
R¹CO—OR² (I)
wherein R¹CO is an aliphatic acyl group containing 12 to 18 carbon atoms and R² is a linear or branched alkyl group containing 1 to 4 carbon atoms; and

(b) a biologically-active ingredient.

The present invention is also directed to a process for treating a target substrate involving contacting the substrate with a pesticide composition containing:

(a) from about 1 to about 80% by weight of a solvent which is a mixture of fatty acid alkyl esters corresponding to formula I:
R¹CO—OR² (I)
wherein R¹CO is an aliphatic acyl group containing 12 to 18 carbon atoms and R² is a linear or branched alkyl group containing 1 to 4 carbon atoms; and

(b) a biologically-active ingredient.

### DETAILED DESCRIPTION OF THE INVENTION

Other than in the operating examples, or where otherwise indicated, all numbers expressing quantities of ingredients or reaction conditions are to be understood as being modified in all instances by the term “about.”

The term “target substrate” as used herein means a plant, a plant pest, or a combination of a plant and a plant pest. A plant pest is defined as any living stage of any insects, mites, nematodes, slugs, snails, protozoa, or other invertebrate animals, bacteria, fungi, other parasitic plants or reproductive parts thereof, viruses; or any organisms similar to or allied with any of the foregoing; or any infectious substances which can directly or indirectly injure or cause disease or damage in any plants or animals or parts thereof; or any processed, manufactured, or other products of plants or animals.

The solvent blends employed in the present invention correspond to formula I:
R¹CO—OR² (I)
wherein R¹CO is an aliphatic acyl group having from 12 to 18 carbon atoms, and R² is a linear or branched alkyl group containing 1 to 4 carbon atoms. Typical examples of the solvent blends include mixtures of alkyl esters of fatty acids such as lauric acid, myristic acid, palmitic acid, palmitoleic acid, oleic acid, stearic acid, linoleic acid and linolenic acid. Mixtures of methyl esters of fatty acids containing 12 to 18 carbons are preferably used.

The fatty acid alkyl esters can be made by transesterification of coconut oil, which forms a crude ester. The crude ester is fractionated into two cuts. The two fractions are designated C6-C10 methyl ester and C12-C18 methyl ester. Natural oils or triglycerides, such as coconut oil, palm kernel oil, and soybean oil, are reacted with sodium methylate and methanol, under appropriate reaction conditions to carry out transesterification, to produce fatty acid methyl esters and crude glycerin. The methyl ester and crude glycerin are then separated into different streams. The methyl ester stream may use two falling film evaporators in series to remove unreacted methanol. The crude fatty acid methyl esters (C6-C18) are fed to a methyl ester fractionation column. The ester is fractionally distilled into precut ester (C6-C10) and the main cut ester (C12-C18). The precut ester is removed as distillate and the main cut is pumped and flash distilled.

The amounts of the respective C12-C1-8 alkyl esters in the solvents used in the present invention may range from about 45% to about 55% for C1-2 alkyl ester; from about 18% to about 25% for C1-4 alkyl ester; from about 8% to about 12% for C1-6 alkyl ester; from about 2% to about 5% for C1-8 alkyl ester; and from about 5% to about 8% for C18:1 alkenyl ester; and from about 1% to about 3% for C18:2 alkenyl ester. Mixtures of methyl esters of the above are particularly preferred in the solvents used in the present invention.

The biologically-active ingredients used to make agricultural pesticide compositions according to the invention are generally selected from the group consisting of insecticides, insect repellents, fungicides, bactericides, bacteriostats, herbicides, and plant growth regulators.

A particularly preferred biologically active ingredient for use in the present invention is 3,4-dichlorophenyl propanamide, i.e., propanil.

By way of the present invention then, there is thus provided a pesticide composition containing: (a) from about 10 to about 99% by weight, preferably from about 20 to about 80% by weight, and most preferably from about 25 to about 55% by weight of a blend of C12-C1-8 alkyl esters and (b) from about 1 to about 80% by weight, preferably from about 5 to about 75% by weight, and most preferably from about 20 to about 55% by weight of a biologically-active ingredient, all weights being based on the weight of the composition.

The pesticide composition of the present invention may also include various types of auxiliaries, adjuvants, solvents, and co-solvents, which serve to further enhance the performance of the pesticide composition.

Suitable nonionic surfactants for use in the present invention include alkoxylated fatty alcohols, alkoxylated fatty acids, alkoxylated fatty ethers, alkoxylated fatty amides, ethoxylated seed oils, ethoxylated mineral oils, nonylphenol ethoxylates, alkoxylated alkyl phenols, ethoxylated glycerides, castor oil ethoxylates, and mixtures thereof.

The anionic surfactants that can be used in the compositions according to the invention are selected from the group consisting of an ethoxylated partial phosphate ester, an alkyl sulfate, an alkyl ether sulfate, a branched alkyl benzene sulfonate, a linear alkyl benzene sulfonate, and an alpha olefin sulfonate.

The alkyl sulfates that can be used in the compositions according to the invention are those wherein the alkyl group has from about 6 to about 22 carbon atoms. The alkyl ether sulfates that can be used in the compositions according to the invention are those wherein the alkyl group has from about 6 to about 22 carbon atoms. The branched alkyl benzene sulfonates that can be used in the compositions according to the invention are those wherein the alkyl group can be branched and has from about 6 to about 22 carbon atoms. The linear alkyl benzene sulfonates that can be used in the compositions according to the invention are those wherein the alkyl group is an essentially unbranched alkyl group having from about 6 to about 22 carbon atoms. The alpha olefin sulfonates that can be used in the compositions according to the invention are those wherein the alkyl group has from about 6 to about 22 carbon atoms.

Auxiliary components may also be added to the compositions of the present invention in order to further enhance the properties thereof. Examples thereof include, but are not limited to, solvents and co-solvents, water-soluble silicone surfactants, oil-soluble silicone surfactants, cationic surfactants, amphoteric surfactants, and the like.

Cationic surfactants which may be employed include, but are not limited to, ethoxylated amines such as ethoxylated tallow amine.

Amphoteric surfactants which may be employed include, but are not limited to, amino acids and their derivatives, amino acid salts, imidazolinium derivatives, alkyl betaines and amidopropyl analogues.

The following is illustrative of the present invention and should not be construed in any manner whatsoever as limiting the scope of the present invention.

### EXAMPLE(S)

### Example 1

The active ingredient, Propanil Technical, was added to 40 grams of a C12-18 methyl ester blend in 0.1 g increments. Mixing was carried out at 45° C. until the residual active ingredient was completely dissolved. Half of the blend was then stored at room temperature and the other half was stored @ 4° C. 24 hrs later, both samples (RT and 4° C.) were inspected for any visible crystals. Other methyl esters or ester blends common to the Ag industry were also tested in a like manner for comparison.

Solubility Tests

The C12-18 blend, according to the invention, was comprised of:

54% C12 methyl ester (laurate)

22% C14 methyl ester (myristate)

11% C16 methyl ester (palmitate)

8% C18:1 methyl ester (oleate)

3% C18 methyl ester (stearate); and

2% C18:2 methyl ester (linoleate).

Results

As demonstrated in TABLE 1, the C12-C18 blend advantageously and surprisingly dissolved more than twice the amount of Propanil technical than its component esters alone; three times as methyl soyate; and 1.4 times as methyl canolate.

TABLE 1

| | Propanil Technical Solubility |
|---|---|
| Ester Solvent¹ | grams Propanil/kg ester |
| C12-C18 methyl ester blend | 869 |
| 96% C12 methyl ester | 370 |
| 70% C12 methyl ester | 428 |
| 95% C14 methyl ester | 333 |
| 95% C8-C10 methyl ester | 370 |
| Methyl Soyate | 269 |
| Methyl Canolate | 612 |

¹See chart below for ester composition

The ester compositions used above:

| Methyl | | | | | | | | | | |
|---|---|---|---|---|---|---|---|---|---|---|
| Ester | | | | | | | | | | |
| Solvent | C6 | C8 | C10 | C12 | C14 | C16 | C18 | C18:1 | C18:2 | C18:3 |
| C12-C18 | — | — | — | 54 | 22 | 11 | 3 | 8 | 2 | — |
| 96% C12 | — | — | 2 | 96 | 2 | — | — | — | — | — |
| 70% C12 | — | — | 1 | 70 | 28 | 1 | — | — | — | — |
| 95% C14 | — | — | — | 3 | 95 | 2 | — | — | — | — |
| 95% C8-C10 | 3 | 55 | 40 | 2 | — | — | — | — | — | — |
| Soyate | — | — | — | — | — | 13 | 4 | 26 | 51 | 6 |
| Canolate | — | — | — | — | — | 4 | 2 | 59 | 21 | 14 |

What is claimed is:

1. A pesticide composition comprising:
(a) from about 10 to about 99% by weight of a solvent which is a mixture of fatty acid alkyl esters corresponding to formula I:
R¹CO—OR² (I)
wherein R¹CO is an aliphatic acyl group containing 12 to 18 carbon atoms and R² is a linear or branched alkyl group containing 1 to 4 carbon atoms; and
(b) a biologically-active ingredient.

2. The composition of claim 1 wherein the solvent is present in the composition in an amount of from about 20 to 80% by weight, based on the weight of the composition.

3. The composition of claim 1 wherein the solvent is present in the composition in an amount of from about 25 to 55% by weight, based on the weight of the composition.

4. The composition of claim 1 wherein the solvent is a mixture of C12-C18 fatty acid methyl esters.

5. The composition of claim 1 wherein the biologically-active ingredient is present in the composition in an amount of from about 5 to about 75% by weight, based on the weight of the composition.

6. The composition of claim 1 wherein the biologically-active ingredient is present in the composition in an amount of from about 20 to about 55% by weight, based on the weight of the composition.

7. A process for treating a target substrate comprising contacting the substrate with a pesticide composition containing:
(a) from about 1 to about 80% by weight of a solvent which is a mixture of fatty acid alkyl esters corresponding to formula I:
R¹CO—OR² (I)
wherein R¹CO is an aliphatic acyl group containing 12 to 18 carbon atoms and R² is a linear or branched alkyl group containing 1 to 4 carbon atoms; and
(b) a biologically-active ingredient.

8. The process of claim 7 wherein the solvent is present in the composition in an amount of from about 2.0 to 60% by weight, based on the weight of the composition.

9. The process of claim 7 wherein the solvent is present in the composition in an amount of from about 2.5 to 45% by weight, based on the weight of the composition.

10. The process of claim 7 wherein the solvent is a mixture of C12-C18 fatty acid methyl esters.

11. The process of claim 7 wherein the biologically-active ingredient is present in the composition in an amount of from about 1 to about 60% by weight, based on the weight of the composition.

12. The process of claim 7 wherein the biologically-active ingredient is present in the composition in an amount of from about 2 to about 50% by weight, based on the weight of the composition.
